(19) United States
(12) Patent Application Publication
(10) Pub. No.: US 2006/0146332 A1
(43) Pub. Date: Jul. 6, 2006

(54) Linear wave guide type surface plasmon resonance microsensor

(76) Inventors: Chii-Wann Lin, Taipei City (TW); Cheng-Lung Lee, Yongkang City (TW); Chih Kung Lee, Taipei City (TW); Way-Seen Wang, Taipei (TW)

Correspondence Address: RABIN & BERDO, P.C., Suite 500, 1101 14th Street, N.W., Washington, DC, 20005, US

(21) Appl. No.: 11/082,882

(22) Filed: Mar. 18, 2005

(30) Foreign Application Priority Data
Jan. 6, 2005 (TW) 094100354

(51) Int. Cl. G01N 21/55

(52) U.S. Cl. 356/445

(57) ABSTRACT

An improved linear wave guide type surface plasmon resonance (SPR) microsensor, particularly a microsensor employing a dual-opening multi-channel design, adopts a cross differential comparison to enhance the performance of the microsensor and uses a surface plated metal thin film to provide a wavelength absorption according to a SPR characteristic and match with an appropriate sized micro-channel to give a highly sensitive high-flux measurement. The invention applied in a water solution sample comprises: a substrate; a bottom layer contacting a surface of the substrate; at least one wave guide layer contacting the bottom layer and the other surface of the substrate; at least two SPR sensing areas on a surface opposite to the contact surface of the wave guide layer and the bottom layer; at least two SPR sensing film layers on a surface opposite to the contact surface of the two PRS sensing areas and the wave guide layer.

### FIELD OF THE INVENTION

The present invention relates to an improved linear wave guide type surface plasmon resonance (SPR) microsensor, and more particularly to a SPR microsensor that employs a dual-opening multi-channel design to achieve a measurement with a cross differential comparison so as to enhance the performance of the wave guide type SPR microsensor, and makes use of a surface plated metal thin film to provide a wavelength absorption according to a special SPR property, and further utilizes an appropriate sized micro-channel to provide a highly sensitive high-flux measurement.

### BACKGROUND OF THE INVENTION

As semiconductor manufacturing technologies become mature, a brand-new area of microsensor technologies is developed. In addition, various Micro-Electro-Mechanical Systems (MEMS) technologies also bring a further step to the development of sensor manufacturing, and the potential of biomedical examination also brings in a huge market of MEMS. At present, the technical products that integrate semiconductor technology, molecular biology, polymer material, artificial intelligence and system integration enter into clinical practices from the laboratory. Among the researches on brand-new innovative ideas, there are many fruitful results of applying the integration of microarray and genetic engineering in the research of gene chips, and such research results are ready to be commercialized. For example, the present development of μTAS microarray can provide 100˜1000 points in 1 μm² for measurements. With the μCE, an automated robotic arm system can load a sample automatically and quickly and may shorten the separation length (to less than 5 cm) and complete the separation within less than 1 sec. With parallel processing, a remote testing for the development of medicines and the requirements for instant analysis can be completed quickly. In the present applications of protein chips, analysis and testing of 1024 samples, each being smaller than 500 ng can be completed within 3 hours. Since the genome project was announced, the demand for testing protein functions becomes increasingly eager, and every country extensively and rapidly develops protein chips. Surface plasmon resonance (SPR) is widely used in the optical method for measuring properties at a surface and an interface. At early stage, physicists discovered and applied SPR in their researches on studying the characteristics of metals and dielectric thin films, and thereafter, chemists applied SPR in their researches of metal/solution interfaces and LB thin films. A SPR sensor demonstrates its instant and highly sensitive measuring capability for biological molecules, and thus SPR sensors are extensively used in the biochemical researches. A surface plasmon can be excited by light energy, electric energy, mechanical energy, or chemical energy produced on a metal or semiconductor interface.

The effect of a plasmon excitation can be measured by the change of intensity when an incident angle or a wavelength is changed. Regardless of adjusting the incident angle or the incident wavelength, the requirements of the thickness and evenness of the metal plating film are 1 nm.

At present, the SPR sensor manufacturing technology mainly uses BK7 as the substrate and employs optical etching and film coating methods to deposit a metal film having wave guide patterns on the substrate. Finally, a high-temperature ion-exchange method is used to implant the ions into the substrate to change the refractive index for the manufacture of a wave guide. To make the wave guide to have the surface plasmon resonance phenomenon, it is necessary to use a semiconductor manufacturing process to deposit a metal layer and a dielectric layer for adjusting a sensing range onto the wave guide as the SPR sensing area. The shortcomings of this method and the low compatibility of the semiconductor manufacturing process are not suitable for mass production.

An alternative method adopts optical fibers, and this method mainly coats a metal on an optical fiber after removing the cladding of the optical fiber as the SPR sensor. The inventor's laboratory had announced similar research results. Although this method has its advantages, the main issue resides on the high level of difficulty of the manufacturing process.

There are two main measuring techniques for SPR wave guide sensors; one of them uses a change of intensity for the measurement and the other uses a change of wavelength for the measurement. The measurement by means of a change of intensity is a more common method, which is also the first measuring method for wave guide SPR sensors. Since the optical loss of a wave guide is large, therefore a more powerful light source such as a laser is required. The wavelength of laser is usually a single wavelength, and thus we can only use the measuring technique by means of a change of intensity.

In a curved wave guide, it is known that an optical loss occurs at a curve. Therefore, the radius of curvature of its curve must be larger than the minimum radius of curvature, and the minimum radius of curvature is determined by its refractive index difference, and the relation between the two must be obtained from actual experiments.

The unique feature of biosensors is to integrate biological elements as a part of the sensing structure, and also connects a transducer to achieve the function of detecting biological functions. Thus biosensors are also known as biochips to cope with the MEMS process. In the development of related chip technologies, an optical method with a high sensitivity is generally adopted as its testing method. Although a fluorescent method is widely used, surface plasmon resonance (SPR) also becomes an important research tool due to its features of not requiring labels and instant measurements. The SPR biosensor is a biosensor that uses optical theories of SPR as a transducer. If the refractive coefficient of a dielectric material in the environment is changed due to its composition, concentration or constituents, the penetrating optical power will reflect the change of SPR resonant angle. The SPR occurs at the interface between a metal and an electrically insulated dielectric material, which is excited by a coupler and a polarized electromagnetic wave (TM-wave), and the indexes of the electric field penetration depth and transversal propagation length will be deteriorated. After a sensing area of a chip goes through the activation process and attaches different antigens (antibodies), the chip can combine its corresponding antigens (antibodies). Theoretically, only an analyzing object having a successful bond will affect the change of the intensity of the reflected light, and any matter exceeding the SPR range will not affect the result of the measurement. Therefore, the level for the identification by using this method is very high. The present SPR research results show that the applications of this method include:

1. Intensity change measuring method (B. Liedberg et. al., Sen. Act. B, 4: 299-304, 1983);

2. Momentum change measuring method (K. Matsubara et. al., Appl. Opt. 27: 1160-1163, 1988);

3. Phase change measuring method (S. G. Nelson et. al, Sen. Act. B, 35: 187-191, 1996);

4. Polarization change measuring method (A. A. Kruchinin et. al., Sen. Act. B 30: 77-80, 1996);

5. Wavelength change measuring method (L. M. Zhang et. al., Electron. Lett. 23: 1469-1470, 1988); and

6. Image change measuring method (C. E. Jordan et. al., Anal. Chem., 69: 1449-1456, 1997).

The design of related SPR resonant components includes:

1. Prism coupler;

2. Grating coupler;

3. Fiber;

4. Wave guide (A. Miliou et. al., IEEE J Quantum Electron, 25: 1889-1897, 1989); and

5. Dielectric coupler (Z. Solomon et. al., Biophy., 73:2791-7, 1997).

Many companies have commercialized this technology into products as follows:

1. Angle Change:
a. Sweden: BIAcore AB (http://www.biacore.com/);
b. United States: Texas Instruments (http://www.ti.com/spr/) and SPRImager (http://www.uwm.edu/);
c. Germany: Xantec Analysensysteme GbR (http://www.xantec.com/)

2. Wavelength Change
a. United States: Quantech (http://www.biosensor.com/)(plastic Au grating);
b. Germany: BioTuL Bio Instruments GmbH (http://www.biotul.com/);
c. United States: EBI Sensors (which is recently merged by BIAcore).

Wherein, the innovative improvements of the design of the SPR resonant components mainly resides on the use of a dielectric coupling layer, and before this, the multilayer film design of the dielectric coupling layer has disclosed a profound theory and a practical design (of which a R.O.C. patent has been granted) to overcome the shortcomings of the existing components and make the components more appropriate for the application of an angle scanning machine or a wavelength scan. The transversal propagation property of a surface plasmon resonance used for the surface molecular measurement of a component (R.O.C. and U.S. patent pending) has been disclosed. The signal change caused by the combination of the surface biological molecules on a biochip is observed within the propagation distance along the metal or surface coating film. With a further integration of micro-channels, a more accurate and smaller structural design is provided. As to the disposable integrated optical components, a wave guide method is attempted to achieve the purpose of miniaturizing the SPR measurement and a component design having sine curvature compensations for reducing the using area and interface as well as a double-channel wave guide component (R.O.C. and U.S. patent pending) were proposed.

The way of designing an improved wave guide type SPR microsensor to overcome the inconvenience of the prior art is the final goal of the present invention.

### SUMMARY OF THE INVENTION

Therefore, it is a primary objective of the present invention to provide an improved linear wave guide type SPR microsensor that improves most of the previous announced SPR sensing devices. The conventional prior SPR sensing devices use a slide as the substrate, adopt a plane design, and require related instruments for carrying out the measurement which is inconvenient for the portability and on-the-spot applications. Most wave guide methods adopt the change of interference of a single sensing area or dual optical paths for the design and manufacture, and thus not providing a multiple-sample measurement or a reference object differential measurement. The present invention employs a dual-opening multi-channel design to achieve a cross differential comparison to enhance the performance of the wave guide type SPR microsensor and uses a surface plated metal thin film to provide a wavelength absorption according to a SPR characteristic and match with an appropriate sized micro-channel to give a highly sensitive high-flux measurement.

The secondary objective of the present invention is to provide an improved linear wave guide type SPR microsensor to overcome an optical loss of a light occurs at the curved section of a wave guide according to a prior art.

Another objective of the present invention is to provide an improved linear wave guide type SPR microsensor that adopts another measuring method to avoid using laser as a light source and adopts the change of intensity for the measurement.

A further objective of the present invention is to provide an improved linear wave guide type SPR microsensor that overcomes the high level of difficulty adopted in a prior art for the manufacture of SPR sensors.

Another objective of the present invention is to provide an improved linear wave guide type SPR microsensor that overcomes the shortcomings of a prior art that uses a BK7 material and a low compatibility for the semiconductor manufacturing process, and such material and compatibility are not suitable for mass production. The invention provides a suitable way for the mass production of SPR sensors.

The wavelength change measurement is a modern measurement capable of lowering an optical loss by the advanced optical fiber technology, and thus it is not necessary to have a very high intensity of light source for the measurement. The advantage of the wavelength change measurement over the intensity change measurement resides on that the measurement is not limited to a certain specific resonant wavelength, and thus the range of refractive index of an analyzing object could be very large without being restricted by the short wavelength of laser beams.

The present invention being applied in a water solution sample comprises: a substrate; a bottom layer contacting a surface of the substrate; at least one wave guide layer contacting the bottom layer and the other surface of the substrate; at least two SPR sensing areas on a surface opposite to the contact surface of the wave guide layer and the bottom layer; at least two SPR sensing film layers on a surface opposite to the contact surface of the two PRS sensing areas and the wave guide layer.

To make it easier for our examiner to understand the characteristics, technical measures, accomplished functions, and objective of the invention, we use a preferred embodiment together with the attached drawings and numerals for the detailed description of the invention.

### BRIEF DESCRIPTION OF THE DRAWINGS

FIG. 1 is a view of the system architecture for carrying out a measurement by changing spectrum according to the present invention;

FIG. 2 is a side view of an improved linear wave guide type surface plasmon resonance microsensor having a self differential comparison function according to the present invention;

FIG. 3 is a perspective view of an improved linear wave guide type surface plasmon resonance microsensor having a self differential comparison function according to the present invention; and

FIG. 4 is a resonant spectrum chart of an improved linear wave guide type surface plasmon resonance microsensor having a self differential comparison function according to the present invention, wherein the chart is obtained by the method of measuring a change of wavelength.

### DETAILED DESCRIPTION OF THE PREFERRED EMBODIMENTS

The present invention relates to an improved linear wave guide type surface plasmon resonance microsensor, which falls into the research field of optical protein biological molecular biochips and is a highly innovative component design and measuring mode focusing on the propagation of a SPR resonant wave of a SPR component to a metal surface. At present, the researches of the SPR components emphasize on how to perform a large-scale research on proteins such as a receptor and a hormone in hope of thoroughly understanding the important functions such as disease mechanism, cell operation mechanism and cell network message. These researches will have a positive effect on the development of new medicines, particularly the medicines that have actions on the protein in a cell, but the bottleneck of the research of this kind resides mainly on its huge consumption of manpower and the requirements of improved sensitivity and miniaturization for being used for on-the-spot measurements. A protein biochip system constructed by the MEMS is urgently required to facilitate the researches related to the factors of a protein with an optimized structure in hope of breaking through the design of new medicine examination, new receptor, molecular structure, and intelligent polymer components.

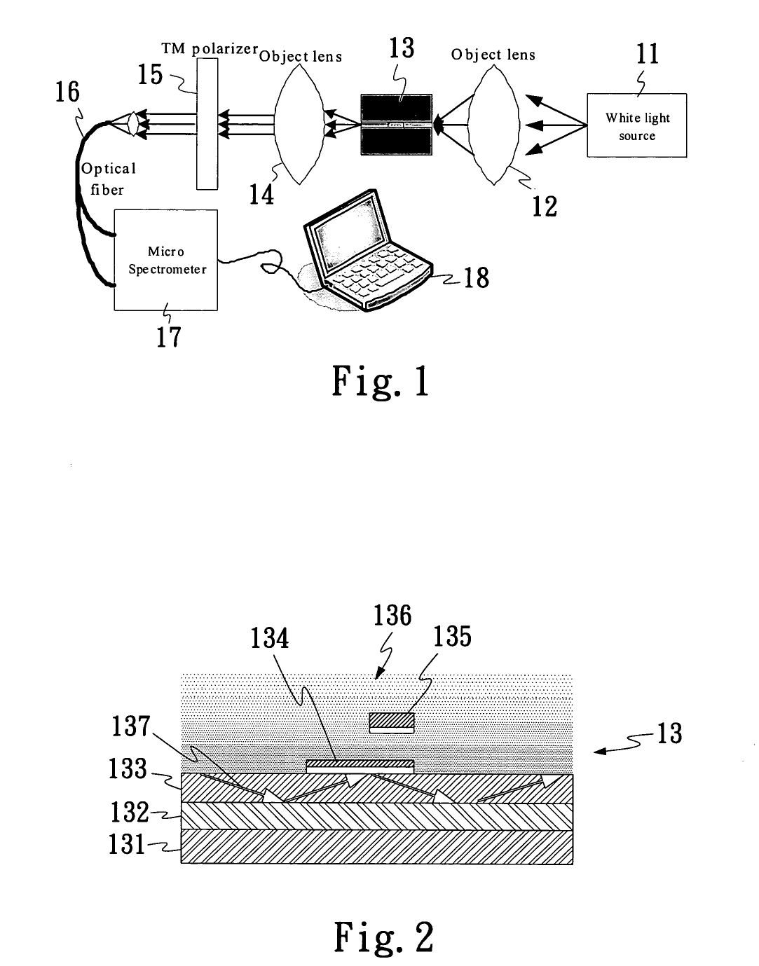

Referring to FIG. 1, a system architecture adopting a spectrum change for the measurement in accordance with the present invention is illustrated. In FIG. 1, the architecture adopts a white light as its light source 11, and the light source 11 is projected inside an improved linear wave guide surface plasmon resonance microsensor (hereinafter referred to as a linear wave guide sensor 13) after passing through a first focusing lens 12, and then the light passes through a second focusing lens 14 and then is polarized by a p polarizer 15. The polarized light (TM wave) is transmitted from an optical fiber 16 to a spectrometer 17, and the signal of the spectrometer 17 is analyzed by a computer for the spectrum analysis. The spectrum of a white light source is continuous; and in other words, it has lights with different kinds of frequencies. If the linear wave guide sensor 13 propagates light by a same mode, the wave vector of each wavelength can be determined by the chromatic dispersion of the linear wave guide sensor 13. The wave vector of a surface plasmon wave is determined by the dielectric coefficient of the testing object and the metal film, and thus when a wave vector of a light wave with a certain wavelength is equal to the wave vector of the surface plasmon wave, then the light intensity of the wavelength at an output end will be greatly deteriorated. The wavelength of the light with a deteriorated intensity at the output end will be related to the value of the dielectric coefficient of the testing object. In other words, different testing objects have different deteriorated wavelengths, and this special property is used to derive the dielectric constant of a testing object on a metal by measuring the wavelength having a drastic deterioration.

Referring to FIG. 2, a side view of an improved linear wave guide type surface plasmon resonance microsensor having a self differential comparison function in accordance with the present invention is shown. In FIG. 2, an improved linear wave guide type surface plasmon resonance microsensor 13 being applied to a water solution sample comprises: a substrate 131, and the substrate is made of any one of the materials selected from a silicon wafer, a glass wafer, and a polymer material; a bottom layer 132 being in contact with a surface of the substrate 131, and the bottom layer 132 is made of any one mixed material selected from SiO2 mixed with a polymer material, SiO2 mixed with germanium and a polymer material, SiO2 mixed with boron and a polymer material, and a photoresist material having a high refractive index mixed with a polymer, and the bottom layer 132 is at least 5 μm thick; a wave guide layer 133 being in contact with a surface opposite to the contract surface of the bottom layer and the substrate 131, and the wave guide layer 133 is made of any one mixed material selected from SiO2 mixed with a polymer material, SiO2 mixed with germanium and a polymer material, SiO2 mixed with boron and a polymer material, and a photoresist material having a low refractive index mixed with a polymer, and the wave guide layer 133 has a thickness of at least 10 μm and a width ranging from 20 μm to 500 μm, and the distance between two waveguide ranges from 500 μm to 5000 μm; two SPR sensing areas 134 being disposed on a surface opposite to the contact surface of the wave guide layer 133 and the bottom layer 132, and the SPR sensing area 134 includes a metal area and a bio-molecular fixed area; two SPR sensing film layers 135 being disposed on a surface opposite to the contact surface of the two SPR sensing areas 134 and the wave guide layer 133, and the SPR sensing film 135 is comprised of an assembly selected from a single layer metal film assembly, a multiple layer dielectric film, and an alloy coating film assembly made of at least two metals, and the SPR sensing film 135 together with a molecular thin film can produce a SPR film stack (not shown in the figure), and the film stack has a wavelength ranging from 400 nm to 1100 nm; and a water solution cladding 136 having a refractive index falling between 1.33 and 1.35 and a thickness of at least 100 μm, wherein a light 137 exists in the wave guide layer 133 and is transmitted by the wave guide layer 133.

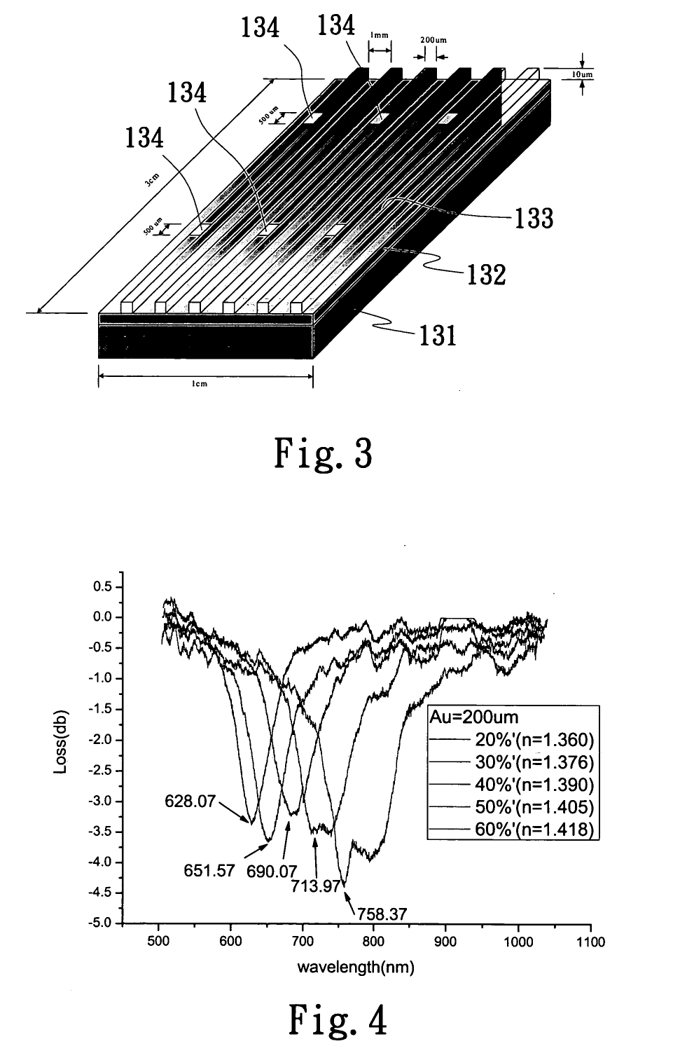

Referring to FIG. 3, a perspective view of an improved linear wave guide type surface plasmon resonance microsensor having a self differential comparison function in accordance with the present invention is shown. In FIG. 3, the relation among the substrate 131, the bottom layer 132, the wave guide 133 and the SPR sensing areas 134 is depicted. Therefore, the figure clearly demonstrates the method of increasing the actual sensing area as described previously. Further, an appropriate sized micro-channel uses a multi-circuit and multi-channel method to improve the sensitivity and provide a highly sensitive and high-flux sensor.

Referring to FIG. 4, a resonant spectrum chart of an improved linear wave guide type surface plasmon resonance microsensor having a self differential comparison function according to the present invention, wherein the chart is obtained by the method of measuring a change of wavelength. In FIG. 4, the SPR values of different wavelengths for glycerols of different concentrations are measured, provided that the length of the sensing area on a SPR sensing film layer 135 is 200 μm. In this embodiment, the present invention adopts a plurality of wave guide layers, two SPR sensing areas, and two SPR sensing film layers to obtain a resonant spectrum chart for the self differential comparison.

In view of the description above, the present invention makes use of the molecular resonance property of a SPR wave, and thus offers a high sensitivity, a fast parallel examination, and a low cost for the wave guide SPR sensing component that requires no fluorescent labels at all. To cope with the trend of a micro and accurate design for optical mechanism, we adopt an incident light ranging from a visible light to a near infrared light to control the loss of a wave power in a wave guide to an acceptable range. With a surface plated metal thin film, wavelength absorption according to a special SPR characteristic is produced. By adjusting the ratio of the sensing area (such as increasing the SPR sensing area and the SPR sensing film layer) and the length of a light coupler, the sample size can be reduced and the innovative application of a highly sensitive differential measurement can be achieved by using a 200 μm area. Based on the foregoing advantages of the improvement, the system according to the present invention is more applicable for micro biosensors. With the booming semiconductor industry and MEMS technologies, the unit cost of a chip can be lowered to enhance a country's competitiveness in the global biomedical industry. The highly parallel, automatic, high-production, micro-size, and fast features of the invention comply with the development of high technologies and thus the invention has improvements over the prior art and is useful to the industry.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An improved linear wave guide type surface plasmon resonance (SPR) microsensor applied to a water solution sample, comprising:
a substrate;
a bottom layer, being in contact with a surface of said substrate;
at least one wave guide layer, being in contact with a surface opposite to the contact surface of said bottom layer and said substrate;
at least two SPR sensing areas, being disposed on a surface opposite to the contact surface of said wave guide layer and said bottom layer;
at least two SPR sensing film layers, being disposed on a surface opposite to the contact surface of the two SPR sensing areas and said wave guide layer.

2. The improved linear wave guide type surface plasmon resonance (SPR) microsensor of claim 1, wherein said substrate is made of a material selected from a collection of a silicon wafer, a glass chip and a polymer material.

3. The improved linear wave guide type surface plasmon resonance (SPR) microsensor of claim 1, wherein said bottom layer is made of a mixed material selected from a collection of SiO₂ mixed with a polymer material, SiO₂ mixed with germanium and a polymer material, SiO₂ mixed with boron and a polymer material, and a photoresist material having a high refractive index mixed with a polymer.

4. The improved linear wave guide type surface plasmon resonance (SPR) microsensor of claim 3, wherein said bottom layer is at least 5 m thick.

5. The improved linear wave guide type surface plasmon resonance (SPR) microsensor of claim 1, wherein said wave guide layer is made of a mixed material selected from a collection of SiO₂ mixed with a polymer material, SiO₂ mixed with germanium and a polymer material, SiO₂ mixed with boron and a polymer material, and a photoresist material having a low refractive index mixed with a polymer.

6. The improved linear wave guide type surface plasmon resonance (SPR) microsensor of claim 5, wherein said wave guide layer is at least 10 m thick.

7. The improved linear wave guide type surface plasmon resonance (SPR) microsensor of claim 5, wherein said wave guide layer has a width ranging from 20 m to 500 m.

8. The improved linear wave guide type surface plasmon resonance (SPR) microsensor of claim 1, wherein said SPR sensing area comprises a metal area and a bio-molecular fixed area.

9. The improved linear wave guide type surface plasmon resonance (SPR) microsensor of claim 1, wherein said SPR sensing film layer is comprised of an assembly selected from a collection of a single layer metal film assembly, a multiple layer dielectric film, and an alloy coating film assembly made of at least two metals.

10. The improved linear wave guide type surface plasmon resonance (SPR) microsensor of claim 1, wherein said SPR sensing layer together with a molecular thin film produces a SPR film stack.

11. The improved linear wave guide type surface plasmon resonance (SPR) microsensor of claim 10, wherein said SPR film stack produced by said SPR sensing film layer together with said molecular thin film has a width ranging from 400 nm to 1100 nm.

12. The improved linear wave guide type surface plasmon resonance (SPR) microsensor of claim 1, further comprising a water solution cladding disposed on a surface opposite to the contact surface of said SPR sensing film layer and said SPR sensing area.

13. The improved linear wave guide type surface plasmon resonance (SPR) microsensor of claim 12, wherein said water solution cladding has a refractive index ranging from 1.33 to 1.35.

14. The improved linear wave guide type surface plasmon resonance (SPR) microsensor of claim 12, wherein said water solution cladding is at least 100 m thick.
